(19) United States
(12) Patent Application Publication
(10) Pub. No.: US 2007/0062638 A1
(43) Pub. Date: Mar. 22, 2007

(54) Foam material and garments made therefrom

(75) Inventor: John Carroll, Rochester (GB)

Correspondence Address: ZARLEY LAW FIRM P.L.C., CAPITAL SQUARE, 400 LOCUST, SUITE 200, DES MOINES, IA, 50309-2350, US

(73) Assignee: Sundridge Tackle Limited, Kent (GB)

(21) Appl. No.: 10/574,457

(22) PCT Filed: May 12, 2003
(86) PCT No.: PCT/GB03/02022

§ 371 Date: Apr. 4, 2006

(51) Int. Cl. B32B 37/00

(52) U.S. Cl. 156/290; 428/304.4

(57) ABSTRACT

A flexible or pliable closed cell foam material (1) in sheet form for forming at least part of a garment, characterized in that the foam material (1) has one or more slits or cuts and/or needle-punched holes (2) therein extending through the sheet from one surface to the other, in which the slits or cuts and/or needle-punched holes (2) are selected to be of a spacing and/or selected to be each of a shape and/or size and/or length as to minimize or not adversely affect the strength and/or shrinkage rate of the foam sheet such as regards the subjection to thermal stability testing and/or compression testing for buoyancy aids, and in which the side surfaces defining the slits and/or holes are normally in abutment and/or close proximity when the sheet is flat or unflexed and separate or press less against each other when flexed to allow air and/or water vapour to pass therethrough.

The present invention concerns a closed cell foam material especially intended for use in flotation suits or other garments or buoyancy aids and to such including the material.

Flotation suits or garments are generally produced having a waterproof outer shell material or fabric which is normally coated on its normally inner side with a breathable polyurethane film or other layer which allows air and/or water vapour to pass through but not water, thus forming a waterproof breathable outer shell or fabric layer. Thus, any water vapour resulting from perspiration of the user can be dispersed through the outer shell to the outside so as to keep the user dry and comfortable.

Floatation suits or other garments or buoyancy aids are made buoyant by having a layer of buoyant plastics material foam stitched as part of the garment inwardly of the outer shell material or fabric. The plastics foam has closed cells, such as air and/or vapour filled bubbles, which provide buoyancy should the user fall into the water. The foam also acts as thermal insulation.

A problem with existing buoyant foam sheet was that it is not breathable i.e. air and/or water vapour cannot pass through it. The wearer of such a garment can, therefore, become uncomfortable through perspiration being unable to be dispersed to the outside of the garment.

Initially we proposed an improved flotation or buoyant foam material in which in order to permit water vapour to pass through the foam apertures in the foam wherein significant amount of material was removed from the foam sheet to leave normally open holes through the foam so as to allow water vapour to pass through. We have now discovered that the use of such holes is not satisfactory because the resultant foam is weakened and/or does not meet, for example, CE safety requirements for buoyancy aids.

We have now discovered that forming through normally open holes in the foam when flat involving removal of a significant amount of material to produce a hole of a shape corresponding to the removed material reduces the thermal stability in that when subject to low temperatures e.g. 30° C. for a period and then returned to normal temperature, the volume or buoyancy characteristics do not return to such as they were originally. Also, when subject to compression tests in which the foam material is compressed for a period and then released, the foam material does not return sufficiently closely to its original thickness to allow it to pass the CE testing or other. In this respect, it is believed the removal of foam material in the formation of holes provides a space into which the foam may spread into during compression and then does not later return on release of the compression.

We have unexpectedly discovered that when slits or cuts and/or needle-punched holes are provided in the foam which does not involve the removal of foam material or involves only minimal removal of material as a result of, e.g. cutting or puncturing, the required characteristics of the foam are maintained within allowable ranges thus enabling the material to be used as a buoyancy aid meeting regulation requirements. The size and/or spacing of the slits or needle-punched holes has or have to be selected so as to make the resultant foam material comply with strength requirements of, for example, CE testing.

According to the present invention there is provided a flexible or pliable closed cell foam material in sheet form for forming at least part of a garment, characterised in that the foam material has one or more slits or cuts and/or needle-punched holes therein extending through the sheet from one surface to the other.

Preferably the closed cell foam material is formed of a synthetic material such as a polymeric foam such as polyurethane or neoprene or any suitable material. The closed cells may contain bubbles of vapour or air.

Preferably the slits or cuts and/or needle-punched holes are selected to be of a spacing and/or selected to be each of a shape and/or size and/or length as to minimise or not adversely affect the strength and/or shrinkage rate of the foam sheet such as relevant in the subjection to thermal stability testing and/or compression testing for meeting quality requirements for buoyancy aids.

The side surfaces defining the slits and/or holes are normally in abutment and/or close proximity when the sheet is flat or unflexed and are such as to advantageously separate or press less against each other when the sheet is flexed to allow air and/or water vapour to pass therethrough. The slits or cuts preferably each comprise at least two intersecting linear slits or so-called “cross-cuts”.

The slits may be in the form of straight line cuts or a cross, for example, an “X” or “+”, or in the form of a “Y” or “V”0 or any other form which will allow the passage of water-vapour on flexing.

The length and/or configuration and/or spacing of the slits or cuts or holes are selected to achieve the required rate passage of water vapour or breathability as required.

Each slit or cut is preferably but not essentially about 3 mm long and/or the foam material is normally in the range of 2 mm to 6 mm thick depending on the buoyancy required.

The sheet foam material is regular or plain or normally planar (i.e. without any dome-like configurations, projections or extensions where the apertures are).

Also according to the invention there is provided a fabric combination comprising a foam or other material as defined above and in the dependent claims in combination with an outer fabric sheet or layer e.g. nylon fabric or polyester or other, which is waterproof or waterproof and water-vapour permeable e.g. by having a hydrophilic or micro-porous or other suitable coating on the inside.

Further according to the present invention, there is provided a garment whenever including a fabric combination as mentioned above or as claimed in the claims, wherein the foam material and outer fabric sheet are stitched or otherwise bonded together in peripheral regions leaving the foam and fabric sheet merely juxtaposed in other regions. Preferably an innermost permeable lining layer will be provided inwardly of the foam material sheet or layer and between the latter and the outer layer a non-woven or other “slip” layer provided to ensure the foam material moves freely relative to the outer layer.

For a jacket, the foam material layer will normally be provided over most of the area thereof—similarly for the upper part of a boiler suit. For leggings and the legs of a boiler suit, a thinner sheet of form or less of such be provided or reduced in the lower regions.

Also according to the present invention there is provided a method of making a closed cell foam material “breathable” i.e. such as to enable air and/or water vapour to pass therethrough, whilst at the same time as not reducing the strength and/or the resilient characteristics as tested for in thermal stability and/or compression testing for buoyancy and device regulations, comprises forming slits or cuts and/or needle-punched holes in the foam material such that no foam material is removed or only consequential minimal amounts are removed in the process and the surfaces defining the slit and/or hole are normally in abutment or in close proximity when flat, and selecting the size and/or spacing of the slits and/or punched holes such as not to impair strength and/or resilient characteristics.

The invention will be described further, by way of example, with reference to the accompanying drawings, in which:

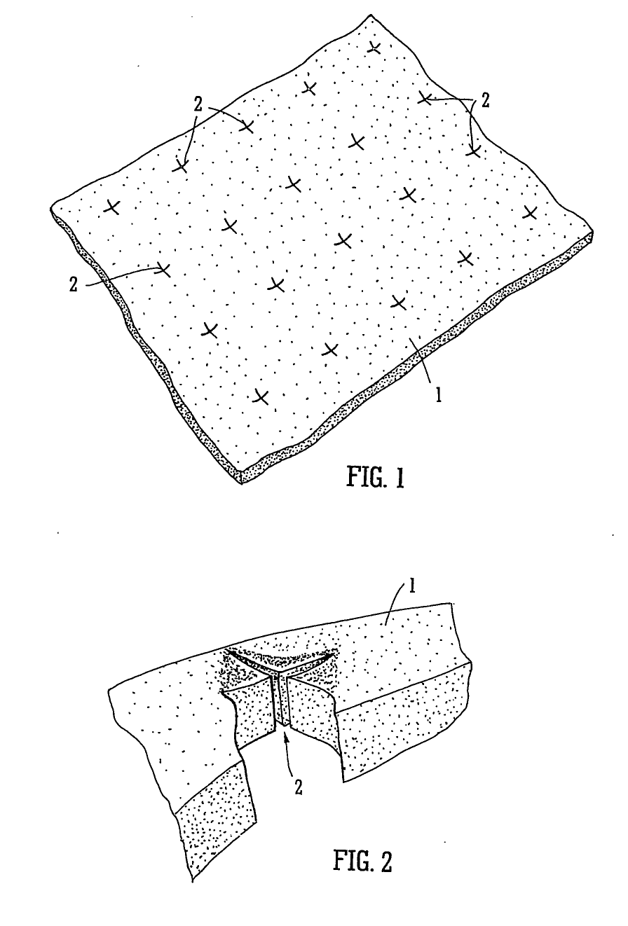

FIG. 1 is a plan view of a part of a flat sheet of closed cell foam material according to the invention;

FIG. 2 is an enlarged partially cut-away fragmentary perspective detail of a cross-cut of the sheet of FIG. 1 but slightly flexed;

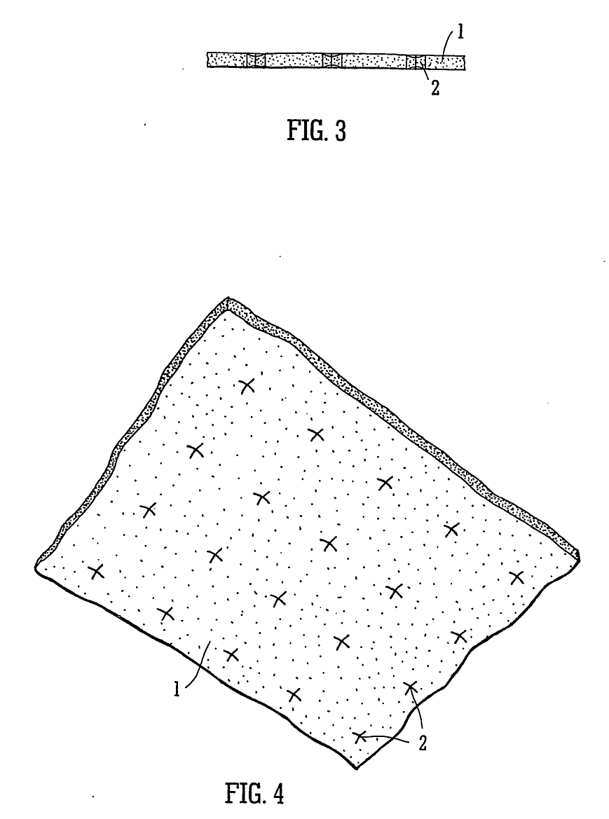

FIG. 3 is a section through three cross cuts of FIG. 1;

FIG. 4 is an inverted plan of part of the flat sheet of FIG. 1;

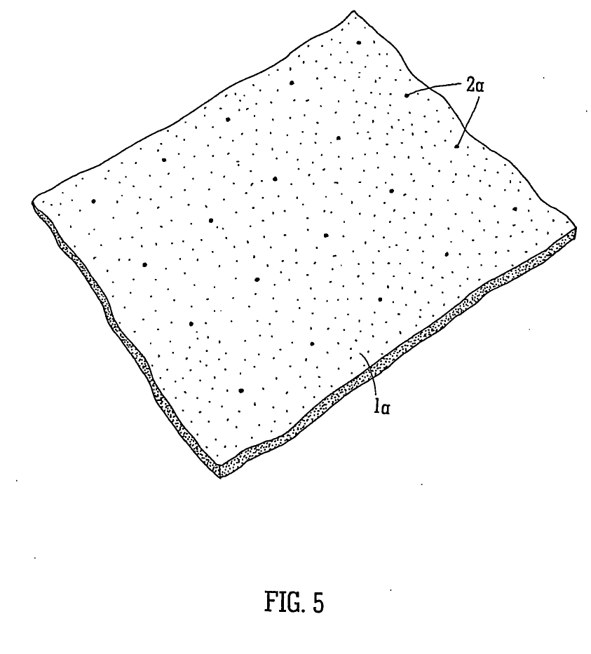

FIG. 5 is a schematic plan of an alternative embodiment having needle-punched holes;

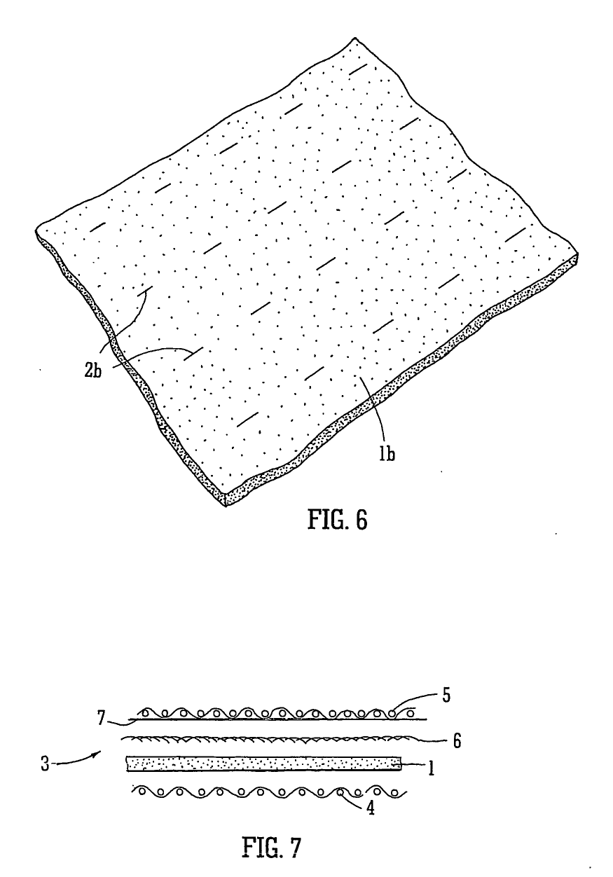

FIG. 6 is a schematic plan of an alternative embodiment having straight line cuts; and

FIG. 7 is a schematic cross section through the layers of a garment including the foam material of FIG. 1 according to the invention.

In FIGS. 1 to 4 a flat flexible closed cell foam material sheet 1 is illustrated which may, for example, be of polyethylene. The sheet is in the region of 3 mm thick.

A plurality of parallel rows of cross-cut slits 2 or cruciform cuts 2 formed by intersecting linear slits of approximately 3 mm length are provided in the sheet 1 extending therethrough from are surface to the opposite surface. The slits 2 are also aligned with slits in adjacent rows.

The slits 2 may be formed by using a razor cutter or knife cutter or like sharp thin cutting device or other method such that foam material is not removed or only a minimal amount is removed from the sheet 1 in the process. The slits 2 are such that when the sheet 1 is laid flat the slits are closed or substantially closed but when the sheet 1 is flexed, the slits 2 open to allow water vapour to pass.

FIG. 5 is a schematic plan illustrating a part of a flexible closed cell foam material sheet 1a wherein a plurality of aligned rows of “needle-punched” holes 2a are provided pierced through the foam sheet 1a. FIG. 6 shows simply straight line elongate slits 2b in such foam material.

The side surfaces of the foamed plastics material defining the slits and/or holes 2, 2a and 2b are normally in abutment and/or close proximity (“substantially closed”) when the sheet is flat or unflexed and are such as to advantageously separate or press less against each other (“open”) when the sheet is flexed to allow air and/or water vapour to pass therethrough. The slits or cuts will preferably comprise elongate slits or at least two intersecting linear slits or so-called “cross-cuts” although many suitable shapes are possible.

FIG. 7 is a schematic cross section through part of a garment 3 including the foam material sheet 1 according to the invention and includes an inner lining fabric layer 4, a outer waterproof and water vapour permeable fabric layer 5 and a non-woven, “slip” layer 6 between the foam layer, and outer layer 5 provided to enable layers 1 and 5 to readily move relative to each other. The outer layer 5 has a hydrophilic polymer coating or micro-porous or other coating 7 on its normally inner surface to provide the mentioned vapour permeability to the outer layer 5. The layers 4, 1, 6 and 5 are stitched together in peripheral/seam regions (not shown).

Also according to the present invention there is provided a flexible buoyant foamed plastics material having vapour or air filled bubbles or closed cells and having cuts or slits or piercings through the foam which do not involve removal of foam material or of only minimal amounts and which cuts or piercings in the unflexed condition of the foam are closed or substantially closed but which open on flexing of the foam such as allow water vapour to pass through the foam.

1. A fabric combination comprising a flexible or pliable closed cell foam material in sheet form for forming at least part of a garment, wherein the foam material is buoyant in water and has one or more slits or cuts and/or needle-punched holes therein extending through the sheet from one surface to the other, and an outer fabric sheet or layer, which is waterproof or waterproof and water-vapour permeable, and characterized in that the foam material and outer fabric sheet are stitched or otherwise bonded together in peripheral regions leaving the foam and fabric sheet merely juxtaposed in other regions.

2. A fabric combination as claimed in claim 1, in which the slits or cuts and/or needle-punched holes are selected to be of a spacing and/or selected to be each of a shape and/or size and/or length as to minimize or not adversely affect the strength and/or shrinkage rate of the foam sheet such as regards the subjection to thermal stability testing and/or compression testing for buoyancy aids.

3. A fabric combination as claimed in claims 1, in which the side surfaces defining the slits and/or holes are normally in abutment and/or close proximity when the sheet is flat or unflexed and separate or press less against each other when flexed to allow air and/or water vapour to pass therethrough.

4. A fabric combination as claimed in any of claims 1, in which the slits or cuts each comprise at least two intersecting linear slits or so-called “crosscuts”.

5. A fabric combination as claimed in any of claims 1, in which the slits are in the form of slits or a cross, for example, an “X” or “+”, or in the form of a “Y” or “V” or any other form which will allow the passage of water-vapour on flexing.

6. A fabric combination as claimed in any of claims 1, in which the closed cells or bubbles contain vapour or air.

7. A fabric combination as claimed in any of claims 1, in which the length and/or configuration and/or spacing of the slits or cuts are selected to achieve the required passage of water vapour or breathability as required.

8. A fabric combination as claimed in any of claims 1, in which the foam material is in the region of approximately 2 mm to 6 mm thick depending on the buoyancy required.

9. A fabric combination as claimed in claim 8, in which the slits or cuts and/or holes are spaced at different intervals as required.

10. A fabric combination as claimed in any of claims 1, in which the sheet is regular or plain or normally planar (i.e. without any dome-like configurations, projections or extensions in the regions where the apertures are).

11. A method of making a fabric combination of an outer waterproof fabric sheet or layer and a closed cell foam material “breathable” or such as to enable air and/or water vapour to pass therethrough whilst at the same time as not reducing the strength and/or the resilient characteristics as tested for in thermal stability and/or compression testing for buoyancy aid device regulations, comprises forming slits or cuts and/or needle-punched holes in the foam material such that no foam material is removed or only minimal foam material is removed in the process and the surfaces defining the slit and/or hole are normally in abutment or in close proximity, and selecting the size and/or spacing of the slits and/or punched holes as not to impair strength and/or resilient characteristics, and stitching or otherwise bonding together the foam material and outer fabric sheet or layer in peripheral regions leaving the foam and fabric sheet/layer merely juxtaposed in other regions.

12. A combination of a waterproof fabric sheet or layer and a flexible buoyant foamed plastics material having vapour or air filled bubbles or closed cells and having cuts or slits or piercings through the foam which do not involve removal of foam material or of only minimal amounts and which cuts or piercings in the unflexed condition of the foam are closed or substantially closed but which open on flexing of the foam such as to allow water vapour to pass through the foam and in which the foam material and outer fabric sheet are stitched or otherwise bonded together in peripheral regions leaving the foam and fabric sheet merely juxtaposed in other regions.

13. A foam material as claimed in claim 12, in which the cuts or slits are elongate slits or “X”-shaped cuts or so called cross-cuts or slits.

14. A garment including a fabric combination comprising a flexible or pliable closed cell foam material in sheet form forming at least a part of a garment, wherein the foam material is buoyant in water and has one or more slits or cuts and/or needle-punched holes therein extending through the sheet from one surface to the other, and an outer fabric sheet or layer, which is waterproof or waterproof and water-vapour permeable, and characterized in that the foam material and outer fabric sheet are stitched or otherwise bonded together in regions so as to leave the foam and fabric sheet merely juxtaposed in other regions.
